(19) United States
(12) Patent Application Publication
(10) Pub. No.: US 2016/0162915 A1
(43) Pub. Date: Jun. 9, 2016

(54) METHOD AND SURVEY SERVER FOR CALCULATING A DYNAMIC INVITATION RATE TO PARTICIPATE TO A WEB SURVEY

(71) Applicant: iPerceptions Inc., Montreal (CA)

(72) Inventors: Lane Cochrane, Kirkland (CA); Matthew Butler, Seattle, WA (US)

(21) Appl. No.: 14/951,643

(22) Filed: Nov. 25, 2015

Related U.S. Application Data
(60) Provisional application No. 62/086,769, filed on Dec. 3, 2014.

(51) Int. Cl. G06Q 30/02

(52) U.S. Cl. CPC G06Q 30/0203; G06Q 30/0201

(57) ABSTRACT

A method and survey server for calculating a dynamic invitation rate to participate to a web survey related to a website. Behavioral data, representative of a series of actions performed by users of a plurality of user devices while visiting the website, are collected and stored at a memory of a survey server. A processing unit of the survey server determines a surprise indicator for a particular user based on the behavioral data collected from the user device of the particular user and the behavioral data from other users stored in the memory. The surprise indicator is representative of a difference of behavior while visiting the website of the particular user with respect to a behavior while visiting the website of the other users. The processing unit calculates the dynamic invitation rate for the particular user based on the determined surprise indicator.

### TECHNICAL FIELD

The present disclosure relates to the field of website analytics via web surveys. More specifically, the present disclosure relates to a method, survey server and computer program product for calculating a dynamic invitation rate to participate to a web survey related to a website.

### BACKGROUND

The usage of web sites to make dedicated web content available to a large public is now prevalent, in relation with the widespread usage of fixed Internet access and mobile Internet access. In particular, e-commerce has become a major component of the economy, in a plurality of business areas such as for example travel agencies, on-line banking, electronics and multimedia retail sales, etc. Web sites in relation to professional services and administration are now also widely used to reach prospects and users.

There is a growing need for the owners of these web sites to better understand whether the visitors are satisfied with their interactions with the web sites, and with the content available on the web sites. There is also a need to determine the level of interest of the visitors with respect to particular contents displayed in particular sections of a web site. One way to obtain such information is to have the visitors answer a web survey before, during, or after the browsing of the web sites. By gathering answers to close ended or open ended questions of the web survey, the user experience with respect to the visit of a web site can be evaluated, as well as the motivation for visiting the web site, the interest for the content displayed, etc.

A static invitation rate is generally set for a specific web site, and invitations to participate to a web survey are sent to visitors of the web site based on the static invitation rate. The invitation rate is the probability to invite a particular visitor of the web site to participate to the web survey. For instance, if the static invitation rate is set to 10%, then on average 10% of the visitors of the web site are invited to participate to the web survey.

One drawback with a static invitation rate is that all visitors of the web site are considered equal, and have the same probability to participate to the web survey. Consequently, there is a risk of gathering redundant information from a plurality of users exhibiting a similar user experience during their visit, while failing to gather sufficient information from a group of users exhibiting an unexpected user experience during their visit. There is therefore a need for a method, survey server and computer program product for calculating a dynamic invitation rate to participate to a web survey related to a website.

### SUMMARY

According to a first aspect, the present disclosure provides a method for calculating a dynamic invitation rate to participate to a web survey related to a website. The method comprises collecting behavioral data from a plurality of user devices. The behavioral data are representative of a series of actions performed by a user of each of the plurality of user devices while visiting the website. The method comprises storing the collected behavioral data at a memory of a survey server. The method comprises determining, by a processing unit of the survey server, a surprise indicator for a particular user based on the behavioral data collected from the user device of the particular user and the behavioral data from other users stored in the memory. The surprise indicator is representative of a difference of behavior while visiting the website of the particular user with respect to a behavior while visiting the website of the other users. The method comprises calculating, by the processing unit, the dynamic invitation rate for the particular user based on the determined surprise indicator.

According to a second aspect, the present disclosure provides a survey server comprising a communication interface, memory and a processing unit. The communication interface exchanges data with user devices. The memory stores behavioral data collected from a plurality of user devices. The collected behavioral data are representative of a series of actions performed by a user of each of the plurality of user devices while visiting a website. The processing unit determines a surprise indicator for a particular user based on the behavioral data collected from the user device of the particular user and the behavioral data from other users stored in the memory. The surprise indicator is representative of a difference of behavior while visiting the website of the particular user with respect to a behavior while visiting the website of the other users. The processing unit further calculates a dynamic invitation rate for the particular user based on the determined surprise indicator.

According to a third aspect, the present disclosure provides a computer program product comprising instructions deliverable via an electronically-readable media, such as storage media and communication links. The instructions comprised in the computer program product, when executed by a processing unit of a survey server, provide for calculating a dynamic invitation rate to participate to a web survey related to a website according to the aforementioned method.

In a particular aspect, a target invitation rate is further taken into consideration in the calculation of the dynamic invitation rate.

In another particular aspect, a current invitation rate is further taken into consideration in the calculation of the dynamic invitation rate.

### BRIEF DESCRIPTION OF THE DRAWINGS

Embodiments of the disclosure will be described by way of example only with reference to the accompanying drawings, in which:

FIG. 1 illustrates a method for calculating a dynamic invitation rate to participate to a web survey related to a website;

FIG. 2 illustrates a survey server for implementing the method of FIG. 1;

FIG. 3 illustrates the display of an invitation to participate to a web survey;

FIG. 4 illustrates the display of survey content;

FIG. 5 illustrates steps preceding and following the method of FIG. 1;

FIGS. 6, 7 and 8 illustrate experimental results for an exemplary algorithm to calculate a dynamic invitation rate.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the adaptation of an invitation rate to participate to a web survey related to a website on a per visitor basis.

The following terminology is used throughout the present disclosure:
Web survey: A web survey aims at collecting user feedback related to the browsing of a web site by a user. The term survey is used in a generic manner, and may include surveys, questionnaires, comment cards, etc.
Invitation rate: Probability to invite a particular visitor of a web site to participate to a web survey related to the web site. The invitation rate is generally static and has the same value for all visitors. The present disclosure aims at calculating a dynamic invitation rate, with a specific value for each particular visitor.
Behavioral data: Data representative of a series of actions performed by a user while visiting a website. Behavioral data include visited web pages, time spent on the visited web pages, specific interactions with the visited web pages, etc. The behavioral data are generally collected from the user device by an analytic server, which further processes the data collected for a plurality of user devices of visitors to the web site.

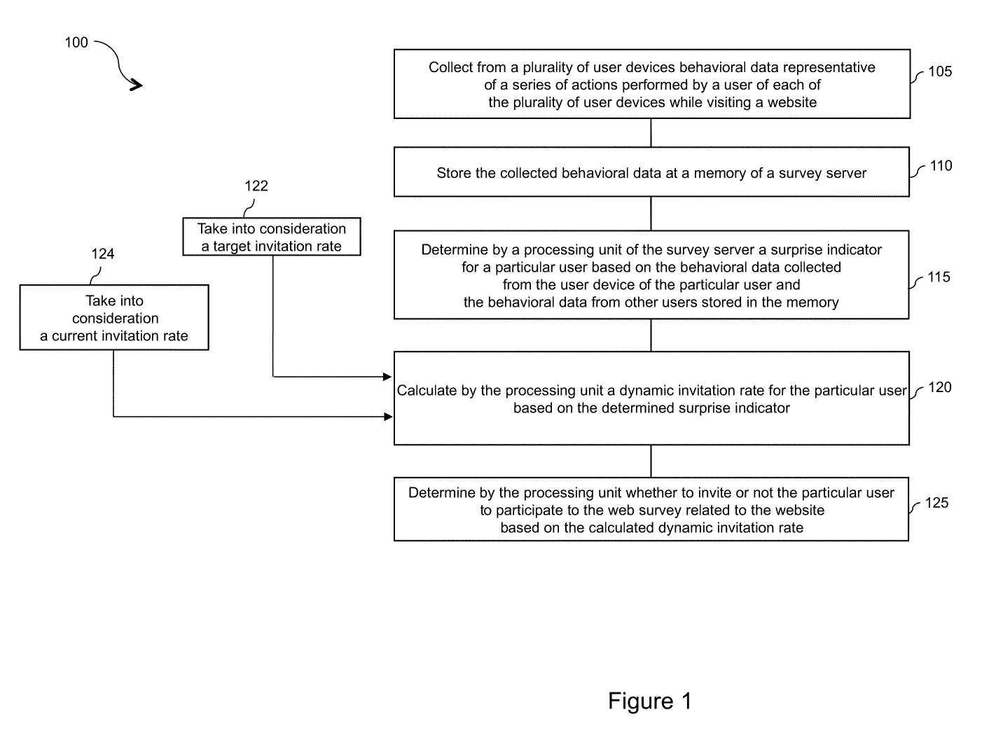

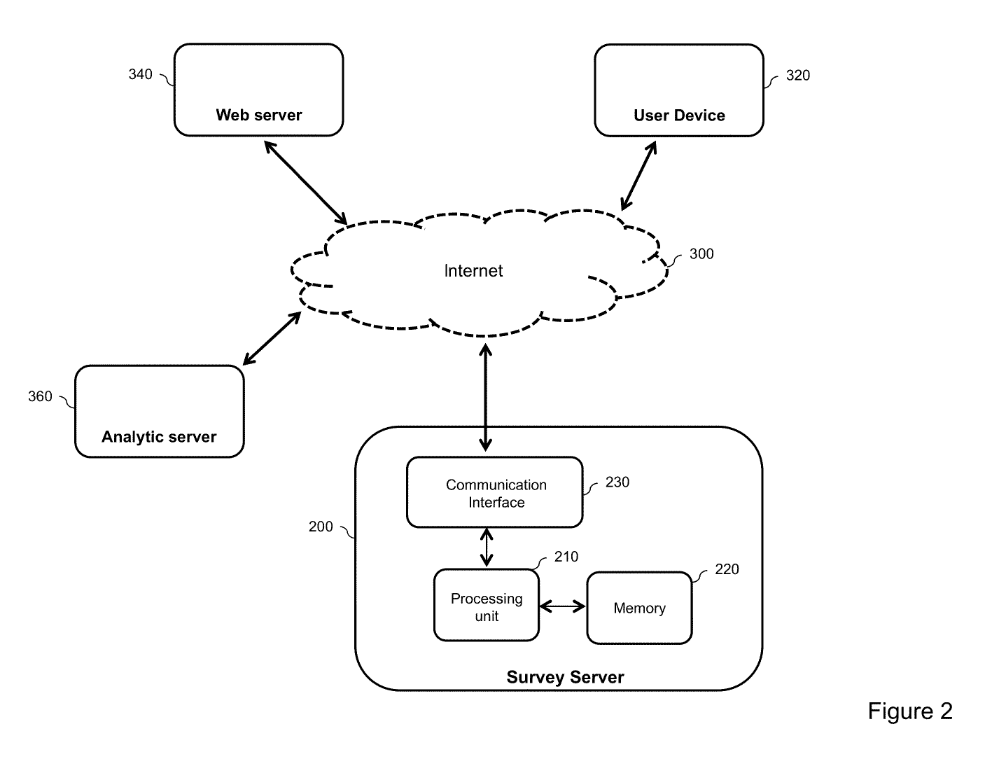

Referring now concurrently to FIGS. 1 and 2, a method 100 and a survey server 200 for calculating a dynamic invitation rate to participate to a web survey related to a website are represented.

The survey server 200 comprises a processing unit 210, having one or more processors (not represented in FIG. 2 for simplification purposes) capable of executing instructions of computer program(s). Each processor may further have one or several cores. The survey server 200 also comprises memory 220 for storing instructions of the computer program(s) executed by the processing unit 210, data generated by the execution of the computer program(s), etc. The survey server 200 may comprise several types of memories, including volatile memory, non-volatile memory, etc. The survey server 200 further comprises a communication interface 230, for exchanging data with other entities, such as a user device 320, a web server 340 and an analytic server 360. The survey server 200 exchange data with the other entities through communication links, generally referred to as the Internet 300 for simplification purposes. Such communication links may include wired (e.g. a fixed broadband network) and wireless communication links (e.g. a cellular network).

In the rest of the description, we refer to instructions of a specific computer program. The instructions of the specific computer program implement the steps of the method 100 executed by the survey server 200. The instructions are comprised in a computer program product (e.g. memory 220) and provide for calculating a dynamic invitation rate to participate to a web survey related to a website, when executed by the processing unit 210 of the survey server 200. The instructions of the computer program product are deliverable via an electronically-readable media, such as a storage media (e.g. a USB key or a CD-ROM) or via communication links 300 through the communication interface 230 of the survey server 200.

The survey server 200 may further comprise a display (e.g. a regular screen or a tactile screen) for displaying data processed and/or generated by the method 100, and a user interface (e.g. a mouse, a keyboard, a trackpad, a touchscreen, etc.) for allowing a user to interact with the survey server 200 when performing the method 100.

The user device 320 may consist of a computer, a laptop, a mobile device (e.g. smartphone, tablet, etc.), an Internet connected television, etc. The user device 320 is capable of retrieving web content from a web server 340 over the Internet 300, and displaying the retrieved web content to a user of the user device 320 via a web browser. The user device 320 comprises a processing unit (for executing instructions of a computer program implementing the web browser), memory, a communication interface (e.g. cellular interface, Wi-Fi interface, Ethernet interface, etc.) for retrieving the web content from the web server 340, a display for displaying the retrieved web content, and a user interface for allowing interactions with the user of the device 320. The components of the user device 320 are not represented in FIG. 2 for simplification purposes.

The web server 340 generally consists of a dedicated computer with high processing capabilities, capable of hosting one or a plurality of web sites. The web server 340 comprises a processing unit, memory, and a communication interface (e.g. Ethernet interface, Wi-Fi interface, etc.) for delivering web content of a hosted web site to the user device 320. The components of the web server 340 are not represented in FIG. 2 for simplification purposes.

Although a single user device 320 is represented in FIG. 2, a plurality of user devices 320 exchange data with the web server 340 in relation to a visit of a particular web site (hosted by the web server 340) by the plurality of user devices 320.

The analytic server 360 also generally consists of a dedicated computer with high processing capabilities for processing a large amount of data received from the user device 320 and/or web server 340. The received data include behavioral data related to visits of a particular web site, hosted by the web server 340 and visited by the user devices 320. The analytic server 360 comprises a processing unit, memory, and a communication interface (e.g. Ethernet interface, Wi-Fi interface, etc.) for receiving the behavioral data. The components of the analytic server 360 are not represented in FIG. 2 for simplification purposes.

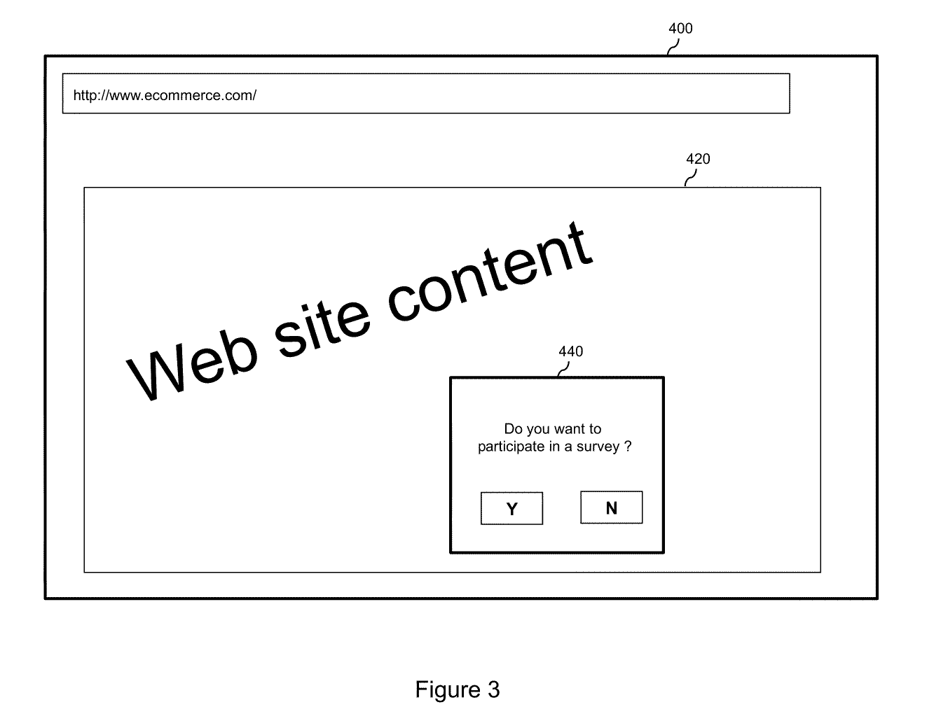

Referring now concurrently to FIGS. 2, 3 and 4, a content of a particular web site (e.g. http://www.ecommerce.com) is displayed in a browsing window 420 of a browser 400 running on the user device 320. At some point during the browsing session of the particular web site (e.g. while displaying the home page http://www.ecommerce.com as illustrated in FIG. 3), an invitation 440 to participate to a web survey related to the particular web site is displayed by the browser 400 (e.g. in an overlay popup window as illustrated in FIG. 3).

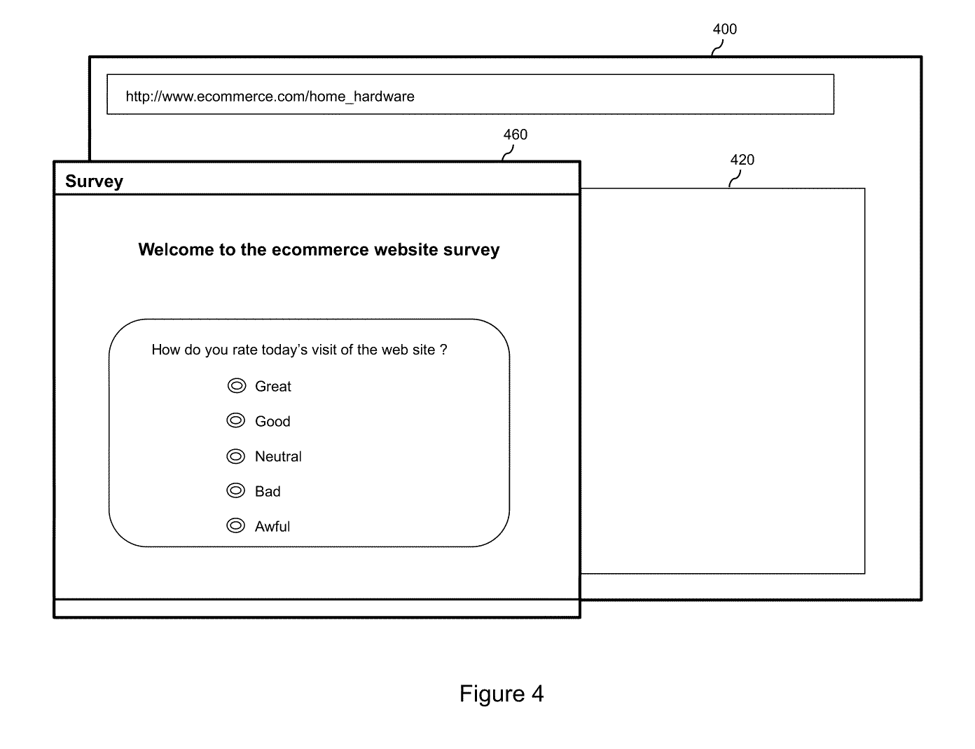

If the owner of the user device 320 accepts the invitation, a survey content is displayed in a survey window 460 displayed by the browser 400 (e.g. in an overlay popup window as illustrated in FIG. 4). The display of the survey content in the survey window 460 may occur immediately after accepting the invitation, or may occur later based on a specific triggering event related to the browsing session (e.g. owner of the user device 320 leaving the particular web site). The survey content displayed in the survey window 460 is transmitted to the user device 320 by the survey server 200 (via its communication interface 230), which hosts a specific survey content in relation to the particular web site. The information provided by the owner of the user device 320 (via the survey window 460) in response to the survey is transmitted to the survey server 200 by the user device 320. The survey server 200 receives information (via its communication interface 230) from a plurality of user devices 320 in response to the specific survey related to the particular web site, and stores the information in the memory 220. The survey server further processes (via the processing unit 210) the stored information, for instance to determine metrics such as a user satisfaction, a user intent, etc.

The invitation 440 to participate to the web survey related to the particular web site hosted by the web server 340 is displayed only for a subset of all the users visiting this particular web site via the browser running on their user device 320. As mentioned previously, a static invitation rate is generally defined for each web survey related to a particular web site, and the display or not of the invitation 440 is determined based on the static invitation rate. The determination can be implemented via one or more scripts hosted by the survey server 200. The content of the particular web site contains a trigger for executing the one or more scripts at a particular point of the browsing session. The one or more scripts may be executed entirely by the browser running on the user device 320, entirely by the processing unit 210 of the survey server 200, or by a combination of the two.

In a first exemplary embodiment, a script executed by the browser running on the user device 320 generates a random number and determines to display or not the invitation 440 based on the random number and the static invitation rate. For example, a static invitation rate of 10% is defined and a random number between 1 and 100 is generated. The invitation 440 is displayed for any random number between 1 and 10 and not displayed for any random number between 11 and 100.

In a second exemplary embodiment, a script executed by the processing unit 210 of the survey server 200 compares a current invitation rate and the static invitation rate. The current invitation rate is calculated based on the determination whether to display or not the invitation 440 for a plurality of user devices 320 for which the determination has already been performed. The current invitation rate is stored by the memory 220 of the survey server 200. If the current invitation rate is lower than the static invitation rate, the invitation 440 is displayed; otherwise it is not displayed. The current invitation rate is updated with the current determination of displaying or not the invitation 440.

The survey server 200 implements a web server functionality for hosting the content of each specific web survey, and for hosting the scripts that perform the determination whether to display or not the invitation 440. The scripts are executed by the processing unit 210, and may themselves trigger the execution of a dedicated software stored in the memory 220, which has access to data stored in the memory 220 and processes these data to participate in the determination whether to display or not the invitation 440.

The present disclosure introduces a new method 100 represented in FIG. 1 for calculating a dynamic invitation rate to participate to a specific web survey related to a particular website. The dynamic invitation rate is used to determine whether to invite or not a user to participate to the web survey, and consequently to display or not the invitation 440.

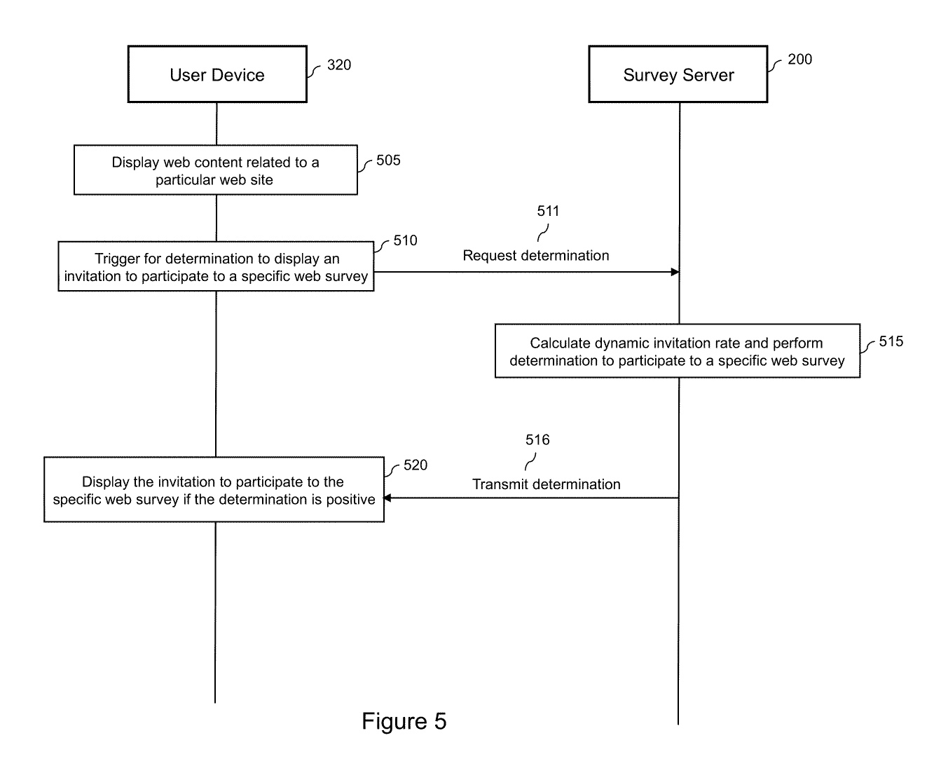

Referring now concurrently to FIGS. 2 and 5, the steps preceding and following the execution of the method 100 (represented in FIG. 1) are illustrated.

The interactions between the user device 320 and the web server 340 for exchanging web content are not represented, since they are well known in the art.

At step 505, the user device 320 displays web content transmitted by the web server 340, and related to a particular web site.

At step 510, a trigger in the displayed web content generates a determination to display or not an invitation to participate to a specific web survey related to the particular web site.

At step 511, the user device 320 transmits a request to perform the determination to the survey server 340. The request usually takes the form of an HTTP request, which may comprise parameters for identifying the specific web survey among a plurality of web surveys managed by the survey server 340.

At step 515, the survey server 340 executes the method 100 (represented in FIG. 1), which comprises calculating a dynamic invitation rate for the user device 320, and performing the determination to participate or not to the specific web survey based on the calculated dynamic invitation rate. As mentioned previously, step 515 is performed by scripts and/or software programs executed by the processing unit 210 of the survey server 200, processing data stored in the memory 220 of the survey server 200.

At step 516, the survey server 200 transmits the determination performed at step 515 to the user device 320.

At step 520, the user device 320 displays the invitation to participate to the specific web survey (as illustrated in FIG. 3) if the determination is positive. If the determination is negative, no invitation is displayed.

In an alternative embodiment, step 510 may be executed by the web server 340 and the determination 516 may be transmitted to the web server 340. The web server 340 then includes in the web content transmitted to the user device 520 the determination, and step 520 can be performed by the user device 220.

Referring back concurrently to FIGS. 1 and 2, the method 100 for calculating a dynamic invitation rate to participate to a web survey related to a website will be detailed.

The method 100 comprises the step 105 of collecting from a plurality of user devices 320 behavioral data representative of a series of actions performed by a user of each of the plurality of user devices 320 while visiting a website.

In a particular aspect, the behavioral data are collected by the survey server 200. As is well known in the art, the behavioral data are first gathered by the user devices 320 or by the web server 340 hosting the website, while the owners of the plurality of user devices 320 are interacting with the website content during a browsing session. The behavioral data are transmitted by either the user devices 320 or the web server 340 to the survey server 200 over the Internet 300, and the behavioral data are received by the survey server 340 via its communication interface 230.

In another particular aspect, the behavioral data are collected by the analytic server 360. The behavioral data are transmitted by either the user devices 320 or the web server 340 to the analytic server 360 over the Internet 300. The analytic server 360 may use the behavioral data to perform its own analysis of the behaviors of the owners of the user devices 320, which is out of the scope of the present disclosure. The behavioral data are further transmitted by the analytic server 360 to the survey server 200 over the Internet 300, and the behavioral data are received by the survey server 340 via its communication interface 230. In a particular embodiment, the analytic server 360 may be integrated with the web server 340. In another particular embodiment, the analytic server 360 may be integrated with the survey server 200.

The method 100 comprises the step 110 of storing the collected behavioral data at the memory 200 of the survey server 200. The processing unit 210 receives the behavioral data via the communication interface 230, and transfers the behavioral data in the memory 200. The processing unit 210 may perform a filtering of the received behavioral data, and discard some of the behavioral data based on pre-determined criteria. The criteria may include at least one of the following: incomplete behavioral data, erroneous behavioral data, irrelevant behavioral data, etc.

The behavioral data for a particular user device 320 may include a unique identifier of the particular user device 320. For instance, if the behavioral data related to a browsing session of the particular user device 320 are received at the survey server 200 in several bundles, the unique identifier is used to aggregate the several bundles of behavioral data in the memory 220. The unique identifier may be generated by the user device 320 (based on a unique characteristic of the user device 320), and stored in a cookie at the user device 320. Alternatively, the unique identifier can be generated by one of the analytic server 360 or survey server 200 (e.g. generation of a unique random number) and stored in a cookie at the user device 320.

The method 100 comprises the step 115 of determining by the processing unit 210 a surprise indicator for a particular user based on the behavioral data collected from the user device 320 of the particular user and the behavioral data from other users stored in the memory 220. The surprise indicator is representative of a difference of behavior while visiting the website of the particular user with respect to a behavior while visiting the website of the other users.

As mentioned previously, the behavioral data for the particular user may be collected in several bundles. Alternatively, they are collected in a single bundle. Once all the behavioral data needed to determine the surprise indicator of the particular user have been collected, the surprise indicator is effectively determined by the processing unit 210. The behavioral data from other users stored in the memory 220 and taken into consideration for the determination of the surprise indicator also need to be complete. For instance, the behavioral data from another user are complete if a surprise indicator has already been determined for this other user.

The determination of the surprise indicator may consist in a calculation by the processing unit 210, the calculation using a pre-defined algorithm for computing the behavioral data of the particular user and the behavioral data of the other users. Alternatively, the determination of the surprise indicator consists in an inference (involving no calculation), the inference using a pre-defined algorithm for comparing the behavioral data of the particular user and the behavioral data of the other users.

The behavioral data used for determining the surprise indicator may comprise at least one of the following: visited web pages of the website, time spent on each visited web page of the website, occurrence of a particular event (e.g. accessing a cart on an e-commerce website, accepting a chat, etc.) during the visit of the website, etc. The determination may take into consideration a single type of behavioral data, or a combination of several types of behavioral data (e.g. visited web pages and time spent on each visited web page).

For instance, if the visited web pages of the website (also referred to as the click-stream of the particular user) are used for determining the surprise indicator, a probability of visiting each web page of the web site can be calculated based on the collected behavioral data stored in the memory 220 (the click-stream of the other users). The surprise indicator for the particular user is calculated by a mathematical formula taking into consideration the probability calculated for each web page visited by the particular user. An example of such a mathematical formula will be given later in the description.

The surprise indicator may consist of a normalized surprise indicator. A raw surprise indicator is first calculated for the particular user, and the normalized surprise indicator is calculated based on the raw surprise indicator, a maximum value among all the raw surprise indicators that have been calculated, and a minimum value among all the raw surprise indicators that have been calculated. An example of calculation of a normalized surprise indicator will be given later in the description.

The method 100 comprises the step 120 of calculating by the processing unit 210 a dynamic invitation rate for the particular user based on the determined surprise indicator. The dynamic invitation rate represents the probability to invite the particular user to the web survey. Each particular user has its own dynamic invitation rate, calculated based on its own surprise indicator. An example of calculation of a dynamic invitation rate will be given later in the description. The calculation of the dynamic invitation rate may further take into consideration additional data. However, the influence of the value of the surprise indicator is as follows: a higher surprise indicator results in a higher dynamic invitation rate.

The method 100 comprises the step 125 of determining by the processing unit 210 whether to invite or not the particular user to participate to the web survey related to the website, based on the calculated dynamic invitation rate. Since the dynamic invitation rate represents the probability to invite the particular user, it can be expressed as a percentage, for example 40%. Thus, the processing unit 210 may generate a random number and determine to invite the particular user based on the random number and the dynamic invitation rate. For example, a random number between 1 and 100 is generated. The particular user is invited for any random number between 1 and 40 and not invited for any random number between 41 and 100.

The goal of the invitation to participate to the web survey is to collect information from the visitors of the website, to better understand their degree of satisfaction with their browsing session of the web site, the intent of their visit to the website, etc. The calculation of the dynamic invitation rate (based on the surprise indicator) for each visitor allows to under sample (have a lower probability of inviting to the web survey) visitors that exhibit behaviors already seen, or for which enough samples (responses to the web survey) have already been captured. It also allows to over sample (have a higher probability of inviting to the web survey) visitors with more surprising behaviors, or behaviors that are under represented in the current samples (responses to the web survey).

In a particular aspect, the method 100 comprises the step (not represented in FIG. 1) of defining a target invitation rate to participate to the web survey. The target invitation rate may be defined by a user, via a user interface of the survey server 200 (not represented in FIG. 2), and stored in its memory 220. Alternatively, the target invitation rate may be received via the communication interface 200 from a third party computing device (not represented in FIG. 2). The target invitation rate is defined prior to performing all the steps of the method 100 represented in FIG. 1. The step 120 of the method 100 takes into consideration 122 the target invitation rate in the calculation of the dynamic invitation rate.

An example of calculation of the dynamic invitation rate based on the surprise indicator and the target invitation rate will be given later in the description. The calculation of the dynamic invitation rate may further take into consideration additional data. However, the influence of the values of the surprise indicator and the target invitation rate is as follows: a higher surprise indicator results in a dynamic invitation rate higher than the target invitation rate, and a lower surprise indicator generally results in a dynamic invitation rate lower than the target invitation rate. For example, having a target invitation rate of 5%, a dynamic invitation rate may be 80% for a particularly unique website visit (high value of the surprise indicator); and reduced to 0.01% for an overly typical website visit (low value of the surprise indicator), or one that is already adequately represented in the current samples (responses to the web survey).

A mean surprise indicator can also be taken into consideration in the calculation of the dynamic invitation rate (as illustrated later in the description). The mean surprise indicator is calculated based on a plurality of surprise indicators than have been determined (for a plurality of users for which behavioral data have been collected). A surprise indicator equal to the mean surprise indicator results in a dynamic invitation rate equal to the target invitation rate. A surprise indicator higher than the mean surprise indicator results in a dynamic invitation rate higher than the target invitation rate, and a surprise indicator lower than the mean surprise indicator results in a dynamic invitation rate lower than the target invitation rate.

In another particular aspect, the method 100 comprises the step (not represented in FIG. 1) of calculating by the processing unit 210 a current invitation rate to participate to the web survey. The current invitation rate is calculated based on the determination whether to invite or not to participate to the web survey a plurality of users for which behavioral data have been collected. The current invitation rate corresponds to an average invitation rate, for all the users for which the determination to invite them or not has been performed so far. The current invitation rate is updated each time step 125 of the method 100 has been completed for a particular user. The step 120 of the method 100 takes into consideration 124 the current invitation rate in the calculation of the dynamic invitation rate, in addition to taking into consideration 120 the target invitation rate. The objective is to fine tune the value of the dynamic invitation rate, so that the value of the current invitation rate converges towards the value of the target invitation rate (minimizing the difference between the values of the current invitation rate and target invitation rate).

An example of calculation of the dynamic invitation rate based on the surprise indicator, the target invitation rate, and the current invitation rate will be given later in the description. The influence of the values of the target invitation rate and current invitation rate is as follows. For a given surprise indicator, the corresponding dynamic invitation rate is lower if the current invitation rate is above the target invitation rate, and higher if the current invitation rate is below the target invitation rate. For example, having a high value for the surprise indicator and a target invitation rate of 20%, the dynamic invitation rate may be 60% if the current invitation rate is not taken into consideration in the calculation. However, if the current invitation rate is taken into consideration and equals 22%, the dynamic invitation rate may be 50%; and if the current invitation rate equals 18%, the dynamic invitation rate may be 70%

In still another particular aspect, the dynamic invitation rate is recalculated in real time when new behavioral data are collected for the particular user. Consequently, if any usual behavior of the particular user (by comparison to the behaviors of other users for which behavioral data have already been collected and stored in memory 220) has occurred, the dynamic invitation rate recalculated in real time takes into consideration the unusual behavior. The corresponding surprise indicator is also determined in real time (before recalculating the dynamic invitation rate), taking into account the unusual behavior, and thus producing a higher value for the surprise indicator. Consequently, the calculated dynamic invitation rate also has a higher value, resulting in the probability to invite the particular user to participate to the web survey being higher when performing the determination at step 125 of the method 100.

If the surprise indicator is determined based on the visited web pages (user click-stream as mentioned previously), it can be determined every time a new web page is visited. The dynamic invitation rate is also recalculated every time a new web page is visited. The determination to invite or not the particular user to the web survey is also performed every time a new web page is visited. However, in order for these steps to be performed in real time, behavioral data representative of the web pages visited by the particular user also need to be transmitted in real time to the survey server 200. For instance, if the particular user demonstrates an usual behavior during a first phase of the click-stream (by comparison to the behaviors of other users for which behavioral data have already been collected and stored in memory 220), a low dynamic invitation rate is calculated in real time, and the probability of the particular user to be invited to participate to the web survey is low. Then, if the particular user demonstrates an unusual behavior during a following phase of the click-stream, an increasing dynamic invitation rate is calculated in real time, and the probability of the particular user to be invited to participate to the web survey increases accordingly.

In an alternative embodiment, behavioral data related to the particular user, and received by the survey server 200, are stored in the memory 220. The determination of the surprise indicator and the calculation of the corresponding dynamic invitation rate are performed based on one (or more) pre-defined criteria, and not every time new behavioral data related to the particular user are received by the survey server 200.

In yet another particular aspect, the determination of the surprise indicator further takes into consideration contextual data. The contextual data may comprise at least one of the following: a hardware configuration of the user devices 320 (e.g. screen characteristics), a software configuration of the user devices 320 (e.g. operating system, browser, etc.), a user configuration of the user devices 320 (e.g. language, country, etc.). The contextual data are collected from the user devices 320 in a similar manner to the behavioral data. In a particular embodiment, a probability of occurrence of a particular parameter (e.g. particular brand of browser, particular language, etc.) among the collected contextual data is calculated based on all the contextual data collected from the user devices 320. The determination of the surprise indicator takes into account this probability when a user device 320 is configured with the particular parameter.

Following is a detailed example of an algorithm and functions for calculating a surprise indicator and corresponding dynamic invitation rate. The dynamic invitation rate further takes into consideration a target invitation rate and a current invitation rate. The calculation of the surprise indicator is based on a click-stream collected from user devices (web pages of a website visited by a user of each user device).

The visited website consist in a collection of web pages, where each web page has a corresponding and unique Uniform Resource Locator (URL) uεU, where U is the set of all URLs on the website. A set of all website visitors V is defined, that represents all the traffic on the website, where each visitor vεV is represented as a collection of URLs visited, v={uᵢ, uᵢ₊₁, . . . , uₗ} and l is the length of a unique visit. The dynamic invitation rate for determining if a visitor (vᵢ) of the website at time t(v_{i,t}) where t<=l will be served an invitation to participate to a web survey related to the website is given by the following function:

Inv(v_{i,t})=θ(1+((sₙ(v_{i,t})−τₜ)/τₜ)) (1)

where sₙ is a normalized surprise indicator of the visit up to time t, θ is the target invitation rate, and τₜ is a time varying parameter which in a static environment would represent the mean surprise indicator. In a following section, it is described how τₜ is adjusted in response to a varying surprise in the website traffic.

The surprise indicator of a website visit is given by the following function:

$$s ( {v}_{i , t} ) = {\sum }_{p = 0}^{t} log ( \frac{1}{{P}^{*} ( {u}_{p} )} ) \qquad ( 2 )$$

This function is based on a measure of self-information within the website visit sequence, where a more self-informative visit is also considered more surprising. The notion of self-information is well known in information theory, and is a measure of how much information (in terms of entropy) is present in an observation. S is the set of all surprise indicators and s(v_{i,t})εS. The surprise indicator s(v_{i,t}) is also preprocessed to be normalized in the range of [0-1], via the following function:

$${s}_{n} ( {v}_{i , t} ) = \frac{s ( {v}_{i , t} ) - min ( S )}{max ( S ) - min ( S )} \qquad ( 3 )$$

where max(S) is the highest value of s(v_{i,t}) across the sample S and min(S) is the lowest value of s(v_{i,t}) across the sample S.

The function P* in formula (2) is the probability of observing a particular URL in a random website visit, augmented by its current sample requirements. The augmented probability of a particular URL is given by the following function:

$${P}^{*} ( u ) = {( \frac{\vert v ∈ V \text{:} u ∈ v \vert}{\vert V \vert} )}^{\frac{1}{1 + exp ( ψ )} + 0.5} \qquad ( 4 )$$

which represents the count of visits that contain the particular URL, divided by the total number of visits. The factor ψ in the exponent is the percentage of the required sample size remaining and is given by the following function;

$$ψ = \frac{( ω - \hat{ω} )}{ω} \qquad ( 5 )$$

where \hat{ω} is the current accumulated sample size for the particular URL and ω is the required sample size given by the following function:

$$ω = \frac{{t}^{2} P ( 1 - P )}{{ε}^{2}} \qquad ( 6 )$$

where t is a confidence level, P is the probability of observing the category of interest in the target variable, and ε is a level of error. Typical values of t and ε are 1.96 and 0.05, which represent a 95% confidence interval and 5% error respectively. For P, a typical value is 0.15 if purchase intent is modelled, where on average about 15% of website visitors have the intent to purchase.

Controlling a target invitation rate is non-trivial, due to the complexity of modern websites. This complexity is compounded by the variability of user sessions, which form the basis by which individual invitation rates (the dynamic invitation rates for each specific visitor) are calculated. Consequently, a method to accommodate a target invitation rate set a priori depends on online adjusting, to respond to the dynamics and evolving nature of visitors browsing sessions and the environment (the particular website). Adjusting the factor τ introduced in function (1) can be achieved in real-time, based on the error between the target invitation rate and the current invitation rate, given by the following function:

εₜ=θ−\hat{θ}ₜ (7)

where εₜ is the error at time t, θ is the target invitation rate introduced in function (1), and \hat{θ} is the current invitation rate. Once the error is calculated, the factor τ is updated according to the following function:

$${τ}_{i} = {τ}_{i - 1} + ηε \frac{\partial Inv}{\partial τ} \qquad ( 8 )$$

where η is the learning rate or amount of influence that the current error εₜ has on the factor τₜ. The partial derivative of the invitation rate with respect to τ is given by the following function:

$$\frac{\partial Inv}{\partial τ} = \frac{- ( {θζ}_{t} )}{τ} \qquad ( 9 )$$

where ζₜ is an estimate of the mean surprise indicator at time t in the website traffic. Using equation (8) to adjust the factor τ results in a near monotonic decrease in the initial error εₜ. After this monotonic decrease, the error εₜ fluctuates at a relatively low variance around 0. The fluctuation in the error εₜ is a consequence of the dynamic nature of website traffic.

As mentioned earlier in the description, the dynamic invitation rate Inv(v_{i,t}) defined by function (1) can be estimated in batch, at the end of a pre-defined period of time, and then adjustments to the factor τ are also determined at that time. However, since the dynamic invitation rate Inv(v_{i,t}) defined by function (1) depends on the surprise indicator s(v_{i,t}) defined by function (2), and surprise is continually altered as the sample (the click-stream of the visitors to the website) is acquired, there is a need to adjust the factor τ in a more real-time an automated fashion. This can be done by estimating the sample rate using an updateable estimate of the 1st moment of the current invitation rate, given by either the running average:

$${ζ}_{t} = ( \frac{1}{N} ) {s}_{n} ( {v}_{i , t} ) + ( \frac{N - 1}{N} ) {ζ}_{t - 1} \qquad ( 10 )$$

or the exponential average:

ζₜ=αsₙ(v_{i,t})+(1−α)ζₜ₋₁ (11)

With respect to the surprise indicator s(v_{i,t}), an estimate of the surprise indicator s(v_{i,t}) in a sequence can be efficiently computed using self-information, I, since self-information possesses the property of additivity, as follows:

I(A+B)=I(A)+I(B) (12)

This property allows the self-information and therefore the surprise indicator to be estimated sequentially, as visitor moves from URL to URL. As shown in function (2), the canonical use of self-information is not used, but it is augmented to take into account the current state of the collected sample (click-stream of the visitor of the website) to calculate the surprise indicator s(v_{i,t}). This augmentation is realized by raising the maximum likelihood estimate of the probability P* of a URL defined in function (4) to a value which reflects the amount of the desired sample collected thus far for the URL under consideration. To reiterate, the value of the exponent is in function (4) is:

$$\frac{1}{1 + exp ( ψ )} + 0.5 \qquad ( 13 )$$

where ψ is the percentage of the desired sample that has been acquired. This function allows the probability P* of a URL to increase when the current sample size is small compared to a fully acquired sample, and decrease when the sample is close to being fully acquired.

Following are experimental results demonstrating the efficacy of the previously described algorithm and functions. A series of experiments using real-world click-stream data test the ability to control the current invitation rate over an extended period of time (the current invitation rate shall be maintained close to the target invitation rate). The target invitation rates to be tested are 0.025, 0.05, and 0.20 along with a varying starting sample size to create the initial maximum likelihood estimates of the probabilities. The starting sample sizes are 10000 (10 k) and 85000 (85 k).

The data used in the experiment are from an online electronics retailer website and contains 96752 records. Each record is a user's click-stream (the behavioral data) during a website visit with associated environment variables.

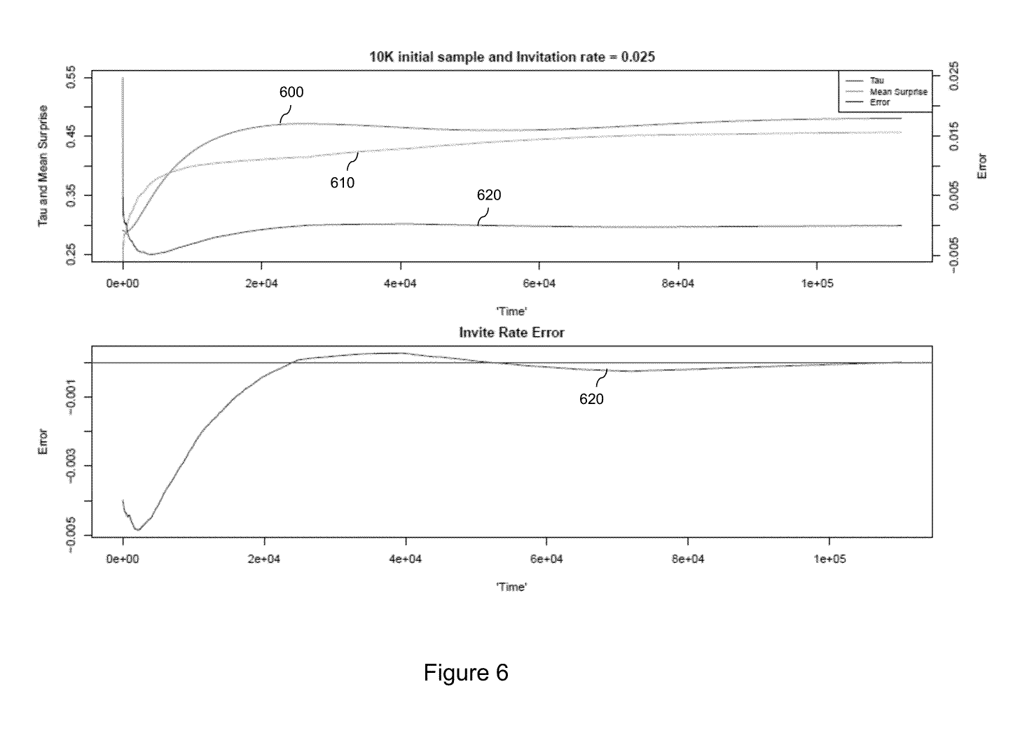

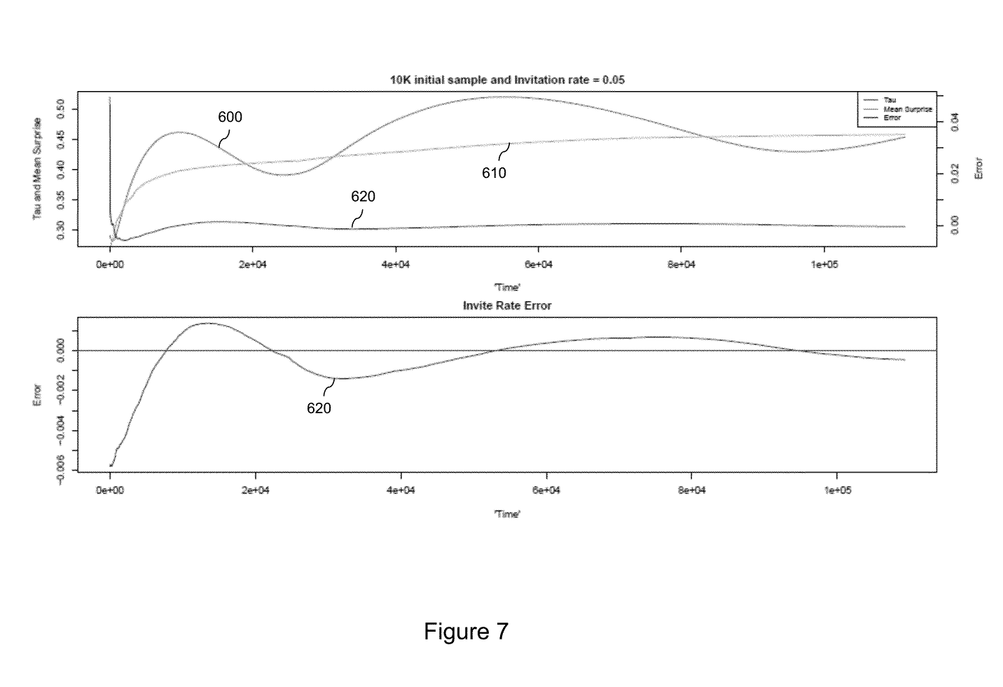

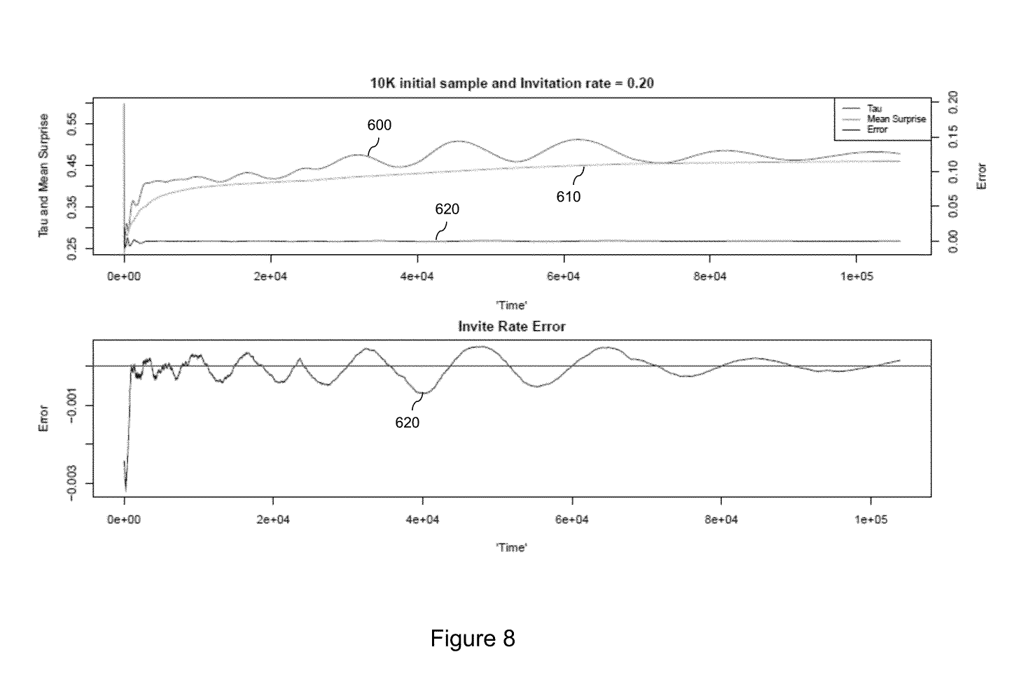

To demonstrate the dynamics of the system, i.e. how the estimate of the mean surprise indicator ζₜ, the factor τₜ, and the error εₜ vary with time, these three variables have been represented in FIGS. 6, 7 and 8 for three experimental set-ups with a 10 k starting sample, and respective target invitation rates of 0.025, 0.05, and 0.20. It can be observed that τₜ (600) and ζₜ (610) continually fluctuate, but that εₜ (620) displays a more monotonically increasing behavior in all three Figures. This increasing behavior is a result of the change in the data set, where after the first 60 k records the URLs represented in the sample dramatically change.

Additionally, after an initial period of erratic movements, the error εₜ (between the current invitation rate and the target invitation rate) continually decreases, until resting at a slight oscillation above and below the 0 error line. From these Figures, it can be verified that τₜ, through its update function (8), was able to learn and continually adapt the dynamic invitation rate as the amount of surprise ζₜ in the system changed (so that the current invitation rate always converges towards the target invitation rate).

An average and a standard deviation of the current invitation rate have been calculated, and are disclosed in the following table. The first line represents the three experimental target invitation rates: 0.025, 0.05 and 0.20. The first column represents the two experimental sample sizes: 10 k and 85 k.

| | 0.025 | 0.05 | 0.20 |
|---|---|---|---|
| 10k | 0.02505/0.00571 | 0.05031/0.01167 | 0.19993/0.04559 |
| 85k | 0.02678/0.00777 | 0.04840/0.01401 | 0.20189/0.05283 |

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for calculating a dynamic invitation rate to participate to a web survey related to a website, comprising:
collecting behavioral data from a plurality of user devices, the behavioral data being representative of a series of actions performed by a user of each of the plurality of user devices while visiting the website;
storing the collected behavioral data at a memory of a survey server;
determining by a processing unit of the survey server a surprise indicator for a particular user based on the behavioral data collected from the user device of the particular user and the behavioral data from other users stored in the memory, the surprise indicator being representative of a difference of behavior while visiting the website of the particular user with respect to a behavior while visiting the website of the other users; and
calculating by the processing unit the dynamic invitation rate for the particular user based on the determined surprise indicator.

2. The method of claim 1, wherein a higher surprise indicator results in a higher dynamic invitation rate.

3. The method of claim 1, further comprising:
determining by the processing unit whether to invite or not the particular user to participate to the web survey related to the website based on the calculated dynamic invitation rate.

4. The method of claim 3, further comprising:
defining a target invitation rate to participate to the web survey; and
taking into consideration the target invitation rate in the calculation of the dynamic invitation rate.

5. The method of claim 4, wherein a mean surprise indicator is calculated for a plurality of users for which behavioral data have been collected, the calculated dynamic invitation rate being higher than the target invitation rate if the calculated surprise indicator is higher than the mean surprise indicator and lower than the target invitation rate if the calculated surprise indicator is lower than the mean surprise indicator.

6. The method of claim 4, further comprising:
calculating by the processing unit a current invitation rate to participate to the web survey, the current invitation rate being calculated based on the determination whether to invite or not to participate to the web survey a plurality of users for which behavioral data have been collected; and
taking into consideration the current invitation rate in the calculation of the dynamic invitation rate.

7. The method of claim 6, wherein for a given surprise indicator, the corresponding dynamic invitation rate is lower if the current invitation rate is above the target invitation rate and higher if the current invitation rate is below the target invitation rate.

8. The method of claim 1, wherein the dynamic invitation rate is recalculated in real time when new behavioral data are collected for the particular user.

9. The method of claim 1, wherein the behavioral data comprise at least one of the following: visited web pages of the website, time spent on each visited web page of the website, occurrence of a particular event during the visit of the website.

10. The method of claim 1, wherein the calculation of the surprise indicator further takes into consideration contextual data comprising at least one of the following: hardware configuration of the user devices, software configuration of the user devices, and user configuration of the user devices.

11. A survey server, comprising:
a communication interface for:
exchanging data with user devices;
memory for:
storing behavioral data collected from a plurality of user devices, the collected behavioral data being representative of a series of actions performed by a user of each of the plurality of user devices while visiting a website;
a processing unit for:
determining a surprise indicator for a particular user based on the behavioral data collected from the user device of the particular user and the behavioral data from other users stored in the memory, the surprise indicator being representative of a difference of behavior while visiting the website of the particular user with respect to a behavior while visiting the website of the other users, and
calculating a dynamic invitation rate for the particular user based on the determined surprise indicator.

12. The survey server of claim 11, wherein the processing unit further collects the behavioral data from the plurality of user devices via the communication interface.

13. The survey server of claim 11, wherein the processing unit further:
determines whether to invite or not the particular user to participate to the web survey related to the website based on the calculated dynamic invitation rate.

14. The survey server of claim 13, wherein a target invitation rate to participate to the web survey is taken into consideration in the calculation of the dynamic invitation rate.

15. The survey server of claim 13, wherein the processing unit further calculates a mean surprise indicator for a plurality of users for which behavioral data have been collected, the calculated dynamic invitation rate being higher than the target invitation rate if the calculated surprise indicator is higher than the mean surprise indicator and lower than the target invitation rate if the calculated surprise indicator is lower than the mean surprise indicator.

16. The survey server of claim 13, wherein the processing unit further calculates a current invitation rate to participate to the web survey, the current invitation rate being calculated based on the determination whether to invite or not to participate to the web survey a plurality of users for which behavioral data have been collected, the current invitation rate being taken into consideration in the calculation of the dynamic invitation rate.

17. The survey server of claim 11, wherein the dynamic invitation rate is recalculated in real time when new behavioral data are collected for the particular user.

18. The survey server of claim 11, wherein the behavioral data comprise at least one of the following: visited web pages of the website, time spent on each visited web page of the website, occurrence of a particular event during the visit of the website.

19. A computer program product comprising instructions deliverable via an electronically-readable media, such as storage media and communication links, which when executed by a processing unit of a survey server provide for calculating a dynamic invitation rate to participate to a web survey related to a website by:
storing behavioral data collected from a plurality of user devices at a memory of the survey server, the collected behavioral data being representative of a series of actions performed by a user of each of the plurality of user devices while visiting the website;
determining a surprise indicator for a particular user based on the behavioral data collected from the user device of the particular user and the behavioral data from other users stored in the memory, the surprise indicator being representative of a difference of behavior while visiting the website of the particular user with respect to a behavior while visiting the website of the other users; and
calculating the dynamic invitation rate for the particular user based on the determined surprise indicator.

20. The computer program product of claim 19, wherein the instructions executed by the processing unit further collect the behavioral data from the plurality of user devices via a communication interface of the survey server.
